(19) United States
(12) Patent Application Publication
(10) Pub. No.: US 2012/0315510 A1
(43) Pub. Date: Dec. 13, 2012

(54) BATTERY PACK WITH BREATHABLE MEMBRANE

(75) Inventors: Broc William TenHouten, Santa Monica, CA (US); Satish Anantharaman, Tianjin (CN)

(73) Assignee: Coda Automotive, Inc., Santa Monica, CA (US)

(21) Appl. No.: 13/155,799

(22) Filed: Jun. 8, 2011

(51) Int. Cl. H01M 10/52; H01M 2/12

(52) U.S. Cl. 429/50; 429/82

(57) ABSTRACT

A battery pack is provided which includes at least one electrochemical rechargeable battery cell, and a housing enclosing the battery cell. At least one inlet is formed in the housing configured such that gas can enter into the housing, and at least one outlet is formed in the housing configured such that gas can exit the housing. The outlet includes a breathable membrane configured such that water vapor can pass through the membrane and outside the housing.

### FIELD

The present invention is directed to a battery pack, and more particularly to a battery pack which includes a breathable membrane allowing for the transmission of moisture out from the battery pack.

### BACKGROUND

Batteries used in electric vehicles may be susceptible to moisture entering into the battery housing and forming condensation if not adequately removed. In many cases, batteries can exhibit reduced performance when they are exposed to this excess moisture and. For example, excess moisture may create condensation which may lead to electrical shortages and potential failures of battery systems. In addition, excess moisture can lead to corrosion.

### SUMMARY

According to one aspect, a battery pack is provided. The battery pack includes at least one electrochemical rechargeable battery cell, a housing enclosing the at least one battery cell, and a ventilation system. The ventilation system includes at least one inlet formed in the housing and configured such that gas can enter into the housing, at least one outlet formed in the housing and configured such that gas can exit the housing, and at least one secondary outlet formed in the housing and configured such that gas can exit the housing, where the at least one secondary outlet includes a breathable membrane configured such that water vapor can pass through the membrane and outside the housing.

According to another aspect, a battery pack is provided. The battery pack includes at least one electrochemical rechargeable battery cell, a housing enclosing the at least one battery cell, at least one inlet formed in the housing and configured such that gas can enter into the housing, and at least one outlet formed in the housing and configured such that gas can exit the housing, where the at least one outlet includes a breathable membrane configured such that water vapor can pass through the membrane and outside the housing.

According to yet another aspect, a method of inhibiting condensation within a battery pack is provided. The method includes providing a housing which encloses at least one electrochemical rechargeable battery cell, the housing including at least one inlet configured such that gas can enter into the housing and at least one outlet configured such that gas can exit the housing. The method includes covering the at least one outlet with a breathable membrane configured such that water vapor can pass through the membrane thereby inhibiting the formation of condensation within the housing.

Various embodiments of the present invention provide certain advantages. Not all embodiments of the invention share the same advantages and those that do may not share them under all circumstances.

Further features and advantages of the present invention, as well as the structure of various embodiments that incorporate aspects of the invention are described in detail below with reference to the accompanying drawings.

### BRIEF DESCRIPTION OF DRAWINGS

The foregoing and other objects and advantages of the invention will be appreciated more fully from the following drawings, wherein like reference characters designate like features, in which:

FIG. 1 is a schematic illustration of a battery pack according to one embodiment;

FIG. 2 is a schematic illustration of an area of the battery pack of FIG. 1, showing a vapor membrane according to an embodiment;

FIG. 3 is a schematic perspective illustration of a battery pack showing multiple vapor membranes;

FIG. 4 is a top schematic illustration of a membrane cover according to one embodiment;

FIG. 5 is a side schematic illustration of the battery pack with breathable membrane incorporating the reinforcement member shown in FIG. 4; and

FIG. 6 is a side schematic illustration of the battery pack with breathable membrane incorporating a top cover.

### DETAILED DESCRIPTION

Applicant recognized that temperature control in battery packs can be challenging. A gas may be transported into a battery pack to control the temperature within the pack, and the gas may include a relatively large amount of water vapor, which can condense on relatively cold portions of the battery pack. As mentioned above, condensation within a battery pack can lead to corrosion and current leakage, among other undesirable effects. These problems can be magnified by the fact that many systems employ battery packs generating relatively large amounts of heat, which are resistant to fast changes in temperature. In addition, it is often undesirable to heat batteries to avoid condensation, as overheating battery pack cells can lead to decreases in system performance.

The embodiments described herein can be used to inhibit the formation of condensation in battery packs in a wide variety of applications. In some cases, the approaches described herein can be used to minimize condensation in a battery pack used to power the drive train of an electric motor vehicle.

As set forth below, Applicant recognized that the use of a breathable membrane in the battery pack may help to inhibit the formation of condensation in the pack. In particular, the breathable membrane may be configured such that vapor within the battery pack can pass through the membrane which prevents the vapor from forming condensation within the pack. As set forth below, the breathable membrane may form part of a passive device to control the amount of vapor within the battery pack.

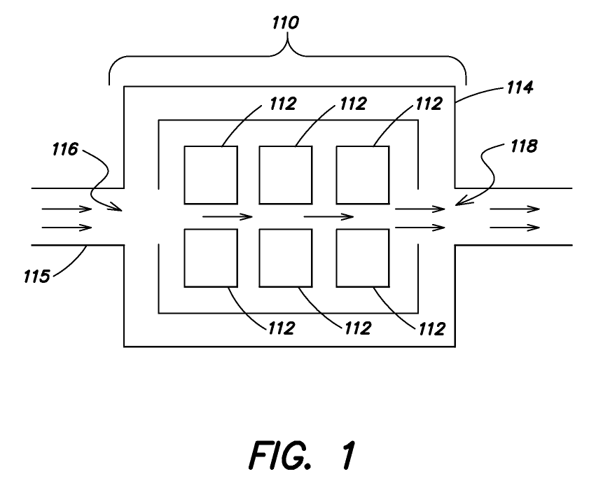

Turning now to the figures, FIG. 1 is a schematic illustration of an exemplary battery pack 110. In FIG. 1, the battery pack 110 includes a plurality of electrochemically rechargeable battery cells 112 arranged within a housing 114. It should be understood that a “battery pack,” as used herein, can include a plurality of battery cells or a single battery cell.

The housing 114 may be configured to protect the battery cells. For example, the housing 114 may be made of a substantially nonporous material to prevent unwanted contaminants from contacting the battery cells. The housing 114 may also be made of a substantially rigid material to protect the battery cells.

Although it may be desirable to completely enclose the battery cells 112 within the housing 114, one or more openings into the housing 114 may be necessary to adequately control the conditions inside the housing 114. Thus, in one embodiment, the battery pack 110 may include a ventilation system which may, for example, be used to control the temperature within the housing 114. The ventilation system 100 may include an inlet 116 formed in the housing and configured such that a gas can enter into the housing (arrows indicate gas flow in and out of battery pack). As shown in the particular embodiment illustrated in FIG. 1, a passageway 115 may be connected to the battery pack via inlet 116.

The ventilation system may also include an outlet 118 formed in the housing and configured such that a gas can exit the housing 114. It is contemplated that the battery pack may include a plurality of inlets 116 and/or a plurality of outlets 118. As illustrated in FIG. 1, when one or more inlet(s) and outlet(s) of the battery pack are opened, gas from outside the battery pack 110 can be transported through the battery pack to control the temperature and/or humidity within at least a region of the battery pack. Any suitable device can be used to move the gas from outside the battery pack into the battery pack (e.g., a pump, fan, etc.). It is also contemplated that ambient air may travel through the housing, such that no external device is required to pump the gas through the housing.

The inlet(s) and outlet(s) and/or the passageway(s) that fluidically connect the battery pack to the outside gas can be arranged in any suitable manner. In some embodiments, the inlet(s) and outlet(s) are arranged to achieve a desired flow profile of gas within the container. For example, in FIG. 1, inlet 116 and outlet 118 are arranged such that the gas is transported along multiple battery cells as it is transported from the inlet to the outlet, as indicated by the arrows in the figure. One of ordinary skill in the art would be capable of arranging the inlet(s) and outlet(s) to achieve a desired flow distribution within the battery packs described herein.

The gas from outside the battery pack 110 can originate from any suitable source. For example, in one embodiment, the gas may comprise air transported directly to the battery pack from outside the device powered by the battery pack (e.g., an automobile, a portable electronics device, etc.) via an air intake system. In some cases, the gas may be transported to the battery pack from another source within the device powered by the battery pack (e.g., from a climate control system within a car, from a compressed air cylinder, etc.). Furthermore, in one embodiment, the gas can be ambient air surrounding the battery pack.

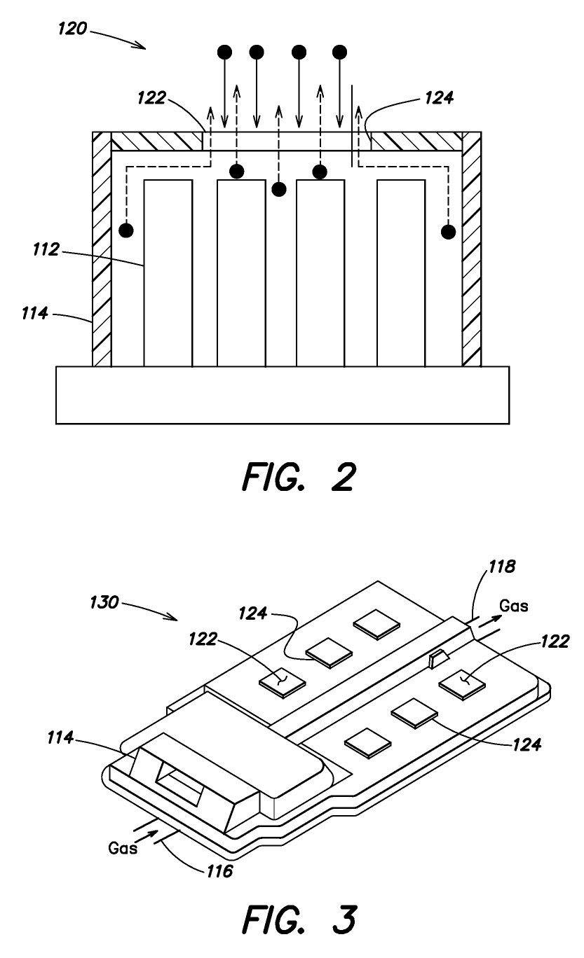

As mentioned above, Applicant recognized that the gas transported into the housing 114 may undesirably include vapor which may cause condensation within the battery pack. Accordingly, in one embodiment illustrated in FIG. 2, a battery pack 120 includes arrangements to reduce the amount of vapor within the battery pack. In particular, this battery pack includes a secondary outlet 124 configured such that gas and vapor can exit through the outlet 124. As mentioned above, it is undesirable for various contaminants to be able to enter into the housing 114. Thus, the secondary outlet may be covered with a breathable membrane 122 configured such that vapor can pass through the membrane and out of the pack, yet as shown in FIG. 2, the membrane 122 may also be configured such that various contaminants, such as, but not limited to dust, and moisture, such as water droplets, cannot pass through the membrane and enter the battery pack 120.

As shown in FIG. 2, in one embodiment, the breathable membrane 122 is located on a top portion of the housing 114. In this embodiment, the membrane 122 is positioned along an uppermost surface of the housing 114. Gas and vapor within the housing 114 may rise in an upward direction, thus it may be advantageous to position the membrane 122 and outlet 124 on a top portion of the housing rather than on a bottom portion of the housing 114, though other locations for the membrane are contemplated, as the invention is not limited in this regard.

Turning to FIG. 3, the housing 114 of the battery pack 130 may include a plurality of outlets 124 which each include a breathable membrane 122 configured for vapor to pass therethrough. As shown, the outlets 124 may be spaced apart along the top portion of the housing 114. In one embodiment, the housing 114 is configured to include a plurality of outlets 124 covered with an associated breathable membrane 122. Thus, as shown in FIG. 2, a plurality of battery cells 112 may be associated with one outlet 124 and membrane 122. For example, as shown in FIG. 2, a battery pack 120 may be configured such that there are four battery cells 112 for each outlet 124 and membrane 122. It is also contemplated that the membrane 122 is positioned in regions of the battery pack housing 114 which have low air circulation. In yet another embodiment, each outlet 124 and membrane 122 may be arranged to be located substantially over a corresponding battery cell 112.

In one illustrative embodiment shown in FIG. 3, the battery pack 130 includes a ventilation system which includes an inlet 116 and an outlet 118 configured such that gas can enter into and exit from the housing. In this embodiment, an outlet 124 and membrane 122 forms a secondary outlet configured such that gas and vapor can exit the housing through either outlet 118 or outlet 124. It is contemplated that the outlet 118 may also include a breathable membrane 122 configured such that gas and vapor can pass therethrough, but various contaminants can not enter the housing.

In another embodiment, the ventilation system may not include a separate outlet 118, and the battery pack may be configured such that gas and vapor exits from the housing 114 through the membrane 122 and outlet 124.

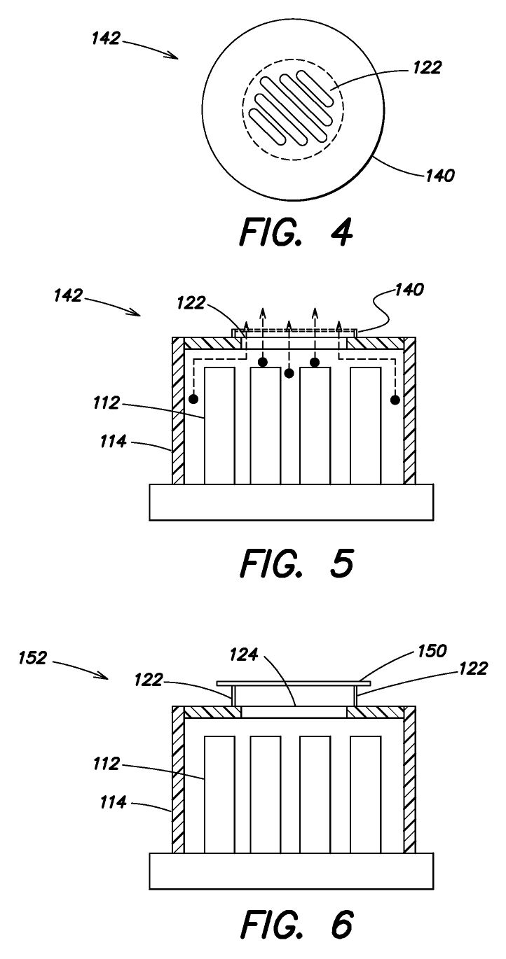

FIGS. 4 and 5 illustrate another embodiment of a battery pack 142 which has a reinforcement member 140 adjacent the breathable membrane 122. In one embodiment, the reinforcement member 140 is configured to protect the membrane 122 (as well as the battery cells within the housing) from external forces. Applicant recognized that external forces imparted by foreign objects may be more prevalent in certain applications, such as, for example, when the battery pack is used in an automotive environment.

As shown in the embodiment illustrated in FIGS. 4 and 5, the protective member 140 may include a grill positioned on opposing sides of the breathable membrane 122. The grill may act as a spacer if, for example, another component is placed on top of the battery pack.

It is also contemplated that the protective member may also include a spaced top cover set off from the grill by standoffs or spacers, in much the same way as a chimney cap, to further protect the membrane and further inhibit foreign particles and debris from puncturing the membrane and/or interfering with the ability of the membrane to pass water vapor to the outside of the battery pack. As shown in the embodiment illustrated in FIG. 6, the battery pack 152 may include a top cover 150 configured to protect the membrane 122. In this particular embodiment, the membrane 122 is coupled to the top cover 150 and is configured to be substantially perpendicular to the outlet 124. It is also contemplated that the cover 150 may be employed with the grill shown in FIG. 5 and where the membrane is substantially parallel with the outlet 124. In one embodiment, the top cover, like the grill itself, may be formed of a thermoplastic material.

One of skill in the art would recognize that a variety of types of materials may be used to form the breathable membrane 122. In one embodiment, the breathable membrane 122 is made of expanded polytetrafluoroethylene (ePTFE). For example, it is contemplated that a GORE-TEX® membrane from W.L. Gore & Associates may be used, though other materials may be employed. It is also contemplated that other materials, such as, but not limited to eVent® fabrics may be used for the breathable membrane.

The pore size of the membrane, which enables gas and vapor to pass through yet which blocks unwanted contaminants from entering the battery pack 120, may vary according to various embodiments. In one embodiment, the diameter of the pores of the membrane 122 is greater than approximately 10 μm. It is contemplated that vapor may not be able to pass through a membrane with a smaller pore size. In another embodiment, the diameter of the pores of the membrane is greater than approximately 20 μm, and in another embodiment, the diameter of the pores of the membrane is greater than approximately 30 μm, and in yet another embodiment, the diameter of the pores of the membrane is greater than approximately 40 μm. If the pore size of the membrane is too large, unwanted contaminants may be able to pass through the membrane. Thus, in one embodiment, the diameter of the pores of the membrane 122 is less than approximately 50 μm. It is contemplated that if the pore size is greater than 50 μm, water droplets may be able to pass through the membrane and into the battery pack. It should be appreciated that there are a variety of ways in which the breathable membrane 122 may be integrated into the housing 114. For example, as shown in FIG. 2, the membrane 122 may be positioned within the outlet 124 such that the outer surface of the housing 114 is substantially flush with the outer surface of the membrane 122. It is also contemplated that the membrane 122 may be recessed within the outlet 124 and/or otherwise spaced from the outer surface of the housing 114 (see, for example, FIG. 6). In an embodiment such as the one disclosed in FIG. 3 where there is a plurality of outlets 124 covered by membranes 122, it is contemplated that the membranes 122 may be formed by separate membranes and/or one or more membranes 122 may be formed of the same sheet, which may, for example, be positioned underneath the outlets 122.

The size of the membrane may vary, and the number of outlets covered by the membranes may vary. In one embodiment, the area of each membrane is approximately one square inch. In one embodiment, the area of each membrane is approximately four square inches. In one embodiment, the area of each membrane is approximately six square inches. In another, the area of each membrane is approximately one square foot. In embodiments which includes multiple outlets 124 and associated membranes, the total area of the membranes is approximately one square foot; in another embodiment, two square feet; in another embodiment, three square feet; in another embodiment, four square feet; and in another embodiment, six square feet. In one embodiment, there are four outlets having approximately 6 square inches each. Though the membranes are shown as being square in shape, other suitable shapes may be employed such as circular, semi-circular, triangular, rectangular, or some other regular or irregular shape.

In one embodiment the area of each membrane is approximately 200 square cm. In another embodiment, the area of each membrane is approximately 500 square cm. Thus, in an embodiment which includes 6 outlets 124 and associated membranes of approximately 500 square cm each, the total area of the membranes is approximately 0.3 square meters.

The vents may be evenly distributed to promote even pack venting, or they may be strategically placed in areas of higher condensation.

There are also a variety of ways in which the membrane 122 may be secured to the housing 114, such as, but not limited to adhesives, fasteners, backing plates, heat welds and clamps. In one embodiment, the membrane(s) may be co-molded with the battery pack housing.

The systems and methods described herein can be used in any suitable system in which a battery pack is employed. In some embodiments, the systems and methods can be used to minimize the amount of vapor and/or condensation within a battery pack system used in an automobile (e.g., within the drive train of an electric or hybrid automobile). In embodiments where the battery pack is used in an automobile, the battery pack can be positioned in any suitable location (e.g., under the floor board, in the trunk, under the front hood, etc.).

Fresh gas supplied to the battery pack can originate from any suitable location. For example, fresh gas may originate from an air intake, the flow of which can be driven by the natural motion of the automobile and/or by a pump or other suitable device. In some cases, the fresh air may exchange heat within and/or be transported through a climate control system of the automobile. In some cases, the climate control system may be specifically constructed and arranged to exchange heat primarily with air used to control the climate within the battery pack. In other cases, the climate control system may be constructed and arranged to exchange heat with separate air streams used to control the climate within the battery pack and the passenger compartment of the automobile. It should be appreciated that in one embodiment, the ventilation system is configured to circulate gas through the housing to cool the battery cell(s), and in another embodiment, the ventilation system is configured to circulate a gas through the housing to heat the battery cell(s).

The battery pack can be formed in any suitable shape (e.g., a rectangular prism, cylinder, sphere, etc.). In addition, the systems and methods described herein can be used with battery packs of any suitable size.

A method of inhibiting condensation within a battery pack may include one or more of the following acts of: providing a housing which encloses at least one electrochemical rechargeable battery cell, the housing including at least one inlet configured such that gas can enter into the housing and at least one outlet configured such that gas can exit the housing, and covering the at least one outlet with a breathable membrane configured such that vapor can pass through the membrane and outside the housing thereby inhibiting the formation of condensation within the housing.

It should be appreciated that various embodiments of the present invention may be formed with one or more of the above-described features. The above aspects and features of the invention may be employed in any suitable combination as the present invention is not limited in this respect. It should also be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one drawing figure, and/or may also encompass embodiments combining components illustrated in multiple different drawing figures.

It should be understood that the foregoing description of various embodiments of the invention are intended merely to be illustrative thereof and that other embodiments, modifications, and equivalents of the invention are within the scope of the invention recited in the claims appended hereto.

1. A battery pack, comprising:
at least one electrochemical rechargeable battery cell;
a housing enclosing the at least one battery cell;
a ventilation system comprising:
at least one inlet formed in the housing and configured such that gas can enter into the housing;
at least one outlet formed in the housing and configured such that gas can exit the housing; and
at least one secondary outlet formed in the housing and configured such that gas can exit the housing, wherein the at least one secondary outlet includes a breathable membrane configured such that water vapor can pass through the membrane and outside the housing.

2. The battery pack of claim 1, wherein the at least one secondary outlet includes a plurality of outlets, the plurality of outlets including a breathable membrane configured such that water vapor can pass through the membrane and outside the housing.

3. The battery pack of claim 1, wherein the breathable membrane is located on a top portion of the housing.

4. The battery pack of claim 1, wherein the pore size of the breathable membrane is less than approximately 50 μm.

5. The battery pack of claim 1, wherein the pore size of the breathable membrane is greater than approximately 10 μm.

6. The battery pack of claim 1, wherein the housing further includes a reinforcement member adjacent the breathable membrane.

7. The battery pack of claim 6, wherein the reinforcement member includes a grill positioned on opposing sides of the breathable membrane.

8. The battery back of claim 6, wherein the reinforcement member includes a top cover.

9. The battery pack of claim 1, wherein the breathable membrane is made of expanded polytetrafluoroethylene (ePTFE).

10. The battery pack of claim 1, wherein the housing is made of a thermoplastic material.

11. The battery pack of claim 1, wherein the ventilation system is configured to circulate gas through the housing to cool the at least one battery cell.

12. The battery pack of claim 1, wherein the ventilation system is configured to circulate gas through the housing to heat the at least one battery cell.

13. The battery pack of claim 1, wherein the ventilation system is configured to circulate air through the housing.

14. The battery pack of claim 1, wherein the at least one electrochemical rechargeable battery cell includes a plurality of electrochemical rechargeable battery cells.

15. The battery pack of claim 1, wherein the battery pack is constructed and arranged to power, at least in part, a vehicle.

16. The battery pack of claim 1, wherein the battery pack is constructed and arranged to power, at least in part, the drive train of a vehicle.

17. A battery pack, comprising:
at least one electrochemical rechargeable battery cell;
a housing enclosing the at least one battery cell;
at least one inlet formed in the housing and configured such that gas can enter into the housing; and
at least one outlet formed in the housing and configured such that gas can exit the housing, wherein the at least one outlet includes a breathable membrane configured such that water vapor can pass through the membrane and outside the housing.

18. The battery pack of claim 17, wherein the at least one outlet includes a plurality of outlets, the plurality of outlets including a breathable membrane configured such that water vapor can pass through the membrane and outside the housing.

19. The battery pack of claim 17, wherein the breathable membrane is located on a top portion of the housing.

20. The battery pack of claim 17, wherein the pore size of the breathable membrane is less than approximately 50 μm.

21. The battery pack of claim 17, wherein the pore size of the breathable membrane is greater than approximately 10 μm.

22. The battery pack of claim 17, wherein the housing further includes a reinforcement member adjacent the breathable membrane.

23. The battery pack of claim 22, wherein the reinforcement member includes a grill positioned on opposing sides of the breathable membrane.

24. The battery back of claim 22, wherein the reinforcement member includes a top cover.

25. The battery pack of claim 17, wherein the breathable membrane is made of expanded polytetrafluoroethylene (ePTFE).

26. The battery pack of claim 17, wherein the housing is made of a thermoplastic material.

27. The battery pack of claim 17, wherein the at least one inlet and outlet are configured to circulate gas through the housing to cool the at least one battery cell.

28. The battery pack of claim 17, wherein the at least one inlet and outlet are configured to circulate gas through the housing to heat the at least one battery cell.

29. The battery pack of claim 17, wherein the at least one inlet and outlet are configured to circulate air through the housing.

30. The battery pack of claim 17, wherein the at least one electrochemical rechargeable battery cell includes a plurality of electrochemical rechargeable battery cells.

31. The battery pack of claim 17, wherein the battery pack is constructed and arranged to power, at least in part, a vehicle.

32. The battery pack of claim 17, wherein the battery pack is constructed and arranged to power, at least in part, the drive train of a vehicle.

33. A method of inhibiting condensation within a battery pack, comprising:
providing a housing which encloses at least one electrochemical rechargeable battery cell, the housing including at least one inlet configured such that gas can enter into the housing and at least one outlet configured such that gas can exit the housing; and
covering the at least one outlet with a breathable membrane configured such that water vapor can pass through the membrane and outside the housing thereby inhibiting the formation of condensation within the housing.
